(19) United States
(12) Patent Application Publication
(10) Pub. No.: US 2023/0348727 A1
(43) Pub. Date: Nov. 2, 2023

(54) HYBRID METAL OXIDE PARTICLES

(71) Applicant: BASF SE, Ludwigshafen Am Rhein (DE)

(72) Inventors: Michael David BURKE, Tarrytown, NY (US); Keith TASK, Beachwood, OH (US); Rupa Hiremath DARJI, Tarrytown, NY (US); Liangliang QU, Tarrytown, NY (US)

(21) Appl. No.: 18/014,929

(22) PCT Filed: Jul. 21, 2021
(86) PCT No.: PCT/IB2021/000485

§ 371 Date: Jan. 6, 2023

Related U.S. Application Data
(60) Provisional application No. 63/055,014, filed on Jul. 22, 2020.

(51) Int. Cl. C09C 1/30; C09C 1/04; C09C 1/40; C09C 3/00; C09C 3/04; C09C 3/06; C09C 3/12

(52) U.S. Cl. CPC C09C 1/3054; C09C 1/3027; C09C 1/3081; C09C 1/309; C09C 1/043; C09C 1/407; C09C 3/006; C09C 3/043; C09C 3/063; C09C 3/12; C01P 2004/64; C01P 2004/62; C01P 2004/61; C01P 2004/32; C01P 2004/84; C01P 2004/03

(57) ABSTRACT

Disclosed in certain embodiments are hybrid metal oxide particles and methods of preparing the same. In at least one embodiment, hybrid metal oxide particles comprise a continuous matrix of a first metal oxide having embedded therein an array of metal oxide particles comprising a second metal oxide. In at least one embodiment, the hybrid metal oxide particles are substantially non-porous.

### CROSS-REFERENCE TO RELATED APPLICATION(S)

This application claims the benefit of priority of U.S. Provisional Application No. 63/055,014, filed on Jul. 22, 2020, the disclosure of which is hereby incorporated by reference herein in its entirety.

### TECHNICAL FIELD

This application relates to metal oxide particles having, for example, structural colorant properties, as well as methods of preparing the same.

### BACKGROUND

Traditional pigments and dyes exhibit color via light absorption and reflection, relying on chemical structure. Structural colorants exhibit color via light interference effects, relying on physical structure as opposed to chemical structure. Structural colorants are found in nature, for example, in bird feathers, butterfly wings and certain gemstones. Structural colorants are materials containing nano-structured surfaces small enough to interfere with visible light and produce color. For example, such materials often contain nanoscale pore structures that contribute to their optical characteristics. However, media infiltration within exposed pores can impact these optical characteristics by changing the net refractive index or by changing the average refractive index within the pores.

### SUMMARY OF THE INVENTION

The following summary presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a method of preparing hybrid metal oxide particles comprises: generating liquid droplets from a particle dispersion comprising first metal oxide particles and second metal oxide particles; drying the liquid droplets to provide dried particles comprising a discrete matrix of the first metal oxide particles embedded with the second metal oxide particles; and heating the dried particles to obtain the hybrid metal oxide particles comprising a continuous matrix formed from the first metal oxide particles embedded with an array of the second metal oxide particles.

In at least one embodiment, the hybrid metal oxide particles are substantially non-porous.

In at least one embodiment, heating the particles comprises sintering or calcining the dried particles to form the continuous matrix by densifying the first metal oxide particles.

In at least one embodiment, the liquid droplets further comprise a binder. In at least one embodiment, heating the dried particles facilitates forming the continuous matrix from the binder and the first metal oxide particles.

In at least one embodiment, the binder comprises a material selected from silica, sodium silicate, magnesium silicate, calcium silicate, aluminum silicate, aluminum oxide hydroxide, sodium oxide, calcium carbonate, calcium aluminate, bentonite, kaolinite, montmorillonite, and combinations thereof.

In at least one embodiment, the first metal oxide particles and the second metal oxide particles independently comprise a metal oxide selected from silica, titania, alumina, zirconia, ceria, iron oxides, zinc oxide, indium oxide, tin oxide, chromium oxide, and combinations thereof.

In at least one embodiment, the first metal oxide particles comprise titania.

In at least one embodiment, the first metal oxide particles have an average diameter from about 1 nm to about 120 nm.

In at least one embodiment, the second metal oxide particles comprise silica.

In at least one embodiment, the second metal oxide particles have an average diameter from about 50 nm to about 999 nm.

In at least one embodiment, one or more of the first metal oxide particles or the second metal oxide particles comprise a core-shell structure.

In at least one embodiment, the second metal oxide particles are spherical metal oxide particles.

In at least one embodiment, one or more of the first metal oxide particles or the second metal oxide particles comprise a surface functionalization. In at least one embodiment, the hybrid metal oxide particles comprise a surface functionalization. In at least one embodiment, the surface functionalization comprises a silane.

In at least one embodiment, the hybrid metal oxide particles have an average diameter from about 0.5 μm to about 100 μm.

In at least one embodiment, generating liquid droplets is performed using a microfluidic process.

In at least one embodiment, generating and drying the liquid droplets is performed using a spray drying process.

In at least one embodiment, generating the liquid droplets is performed using a vibrating nozzle.

In at least one embodiment, drying the droplets comprises evaporation, microwave irradiation, oven drying, drying under vacuum, drying in the presence of a desiccant, or a combination thereof.

In at least one embodiment, the liquid dispersion is an aqueous dispersion, an oil dispersion, an organic solvent dispersion, or a combination thereof.

In at least one embodiment, a weight to weight ratio of the first metal oxide particles to the second metal oxide particles is from about 1/50 to about 10/1.

In at least one embodiment, a weight to weight ratio of the first metal oxide particles to the second metal oxide particles is about 2/3.

In at least one embodiment, a particle size ratio of the first metal oxide particles to the second metal oxide particles is from 1/20 to 1/5.

In at least one embodiment, the array of the second metal oxide particles is an ordered array.

In at least one embodiment, the array of the second metal oxide particles is a disordered array.

In another aspect of the present disclosure, a method of preparing hybrid metal oxide particles comprises: generating liquid droplets from a particle dispersion comprising a sol-gel matrix of a precursor of a first metal oxide and particles comprising a second metal oxide; and drying the liquid droplets and densifying the sol-gel matrix into a continuous matrix to produce the hybrid metal oxide particles, the hybrid metal oxide particles comprising an array of the particles comprising the second metal oxide. In at least one embodiment, the array of the particles is embedded in the continuous matrix.

In at least one embodiment, the precursor comprises one or more of a metal alkoxide or a metal chloride.

In at least one embodiment, the precursor is selected from tetraethyl orthosilicate (TEOS), tetramethyl orthosilicate (TMOS), titanium ethoxide, aluminum oxide hydroxide, zirconium hydroxide, zirconium acetate, zirconium oxychloride, aluminum chloride hexahydrate, aluminum chloride, cerium nitrate, cerium dioxide, zinc acetate, zinc acetate dehydrate, tin chloride dehydrate, and combinations thereof.

In another aspect of the present disclosure, a method of preparing hybrid metal oxide particles comprises: generating liquid droplets comprising a first binder and a second binder; drying the liquid droplets to provide dried particles comprising a matrix of the first binder embedded with a template of the second binder; and heating the dried particles to obtain the hybrid metal oxide particles comprising a continuous matrix formed from the first binder embedded with an array of the second binder.

In at least one embodiment, the first binder and the second binder are independently selected from sodium silicate, magnesium silicate, calcium silicate, aluminum silicate, aluminum oxide hydroxide, sodium oxide, calcium carbonate, calcium aluminate, bentonite, kaolinite, montmorillonite, and combinations thereof.

In another aspect of the present disclosure, hybrid metal oxide particles comprise a continuous matrix of a first metal oxide having embedded therein an array of metal oxide particles, the metal oxide particles comprising a second metal oxide. In at least one embodiment, the hybrid metal oxide particles are substantially non-porous.

In at least one embodiment, the first metal oxide and the second metal oxide independently comprise a metal oxide selected from silica, titania, alumina, zirconia, ceria, iron oxides, zinc oxide, indium oxide, tin oxide, chromium oxide, and combinations thereof.

In at least one embodiment, the first metal oxide comprises titania.

In at least one embodiment, the hybrid metal oxide particles are derived from metal oxide particles comprising the first metal oxide having an average diameter from about 1 nm to about 120 nm.

In at least one embodiment, the second metal oxide comprises silica.

In at least one embodiment, the metal oxide particles have an average diameter from about 50 nm to about 999 nm.

In at least one embodiment, the metal oxide particles comprise a core-shell structure.

In at least one embodiment, the metal oxide particles are spherical metal oxide particles.

In at least one embodiment, the metal oxide particles comprise a surface functionalization. In at least one embodiment, the hybrid metal oxide particles comprise surface functionalization on outer surfaces of the hybrid metal oxide particles. In at least one embodiment, the surface functionalization comprises a silane.

In at least one embodiment, the hybrid metal oxide particles have an average diameter from about 0.5 μm to about 100 μm.

In at least one embodiment, a weight to weight ratio of the first metal oxide to the second metal oxide is from about 1/50 to about 10/1.

In at least one embodiment, a weight to weight ratio of the first metal oxide to the second metal oxide is about 2/3.

In at least one embodiment, the array of the metal oxide particles is an ordered array.

In at least one embodiment, the array of the metal oxide particles is a disordered array.

In at least one embodiment, the hybrid metal oxide particles further comprise a light absorber. In at least one embodiment, the light absorber is present from 0.1 wt % to about 40.0 wt %. In at least one embodiment, the light absorber comprises carbon black. In at least one embodiment, the light absorber comprises one or more ionic species.

Another aspect of the present disclosure is directed to a method of preparing hybrid metal oxide particles, the method comprising: generating liquid droplets from a particle dispersion comprising a binder and metal oxide particles; and drying the liquid droplets to form hybrid metal oxide particles comprising a matrix of the binder and an array of the metal oxide particles embedded in the matrix.

In at least one embodiment, the method further comprises heating the hybrid metal oxide particles to densify the matrix and form a continuous matrix of the binder. In at least one embodiment, the binder comprises a material selected from silica, sodium silicate, magnesium silicate, calcium silicate, aluminum silicate, aluminum oxide hydroxide, sodium oxide, calcium carbonate, calcium aluminate, bentonite, kaolinite, montmorillonite, and combinations thereof, and wherein the metal oxide particles comprise a metal oxide selected from silica, titania, alumina, zirconia, ceria, iron oxides, zinc oxide, indium oxide, tin oxide, chromium oxide, and combinations thereof.

Another aspect of the present disclosure is directed to hybrid metal oxide particles prepared by the aforementioned processes and the processes described herein.

Another aspect of the present disclosure is directed to hybrid metal oxide particles comprising: a matrix of a first metal oxide having embedded therein metal oxide particles comprising a second metal oxide. In at least one embodiment, the hybrid metal oxide particles are substantially non-porous, and the hybrid metal oxide particles are sintered.

Another aspect of the present disclosure is directed to a composition comprising a substrate and the hybrid metal oxide particles described herein.

Other aspects of the present disclosure are directed to compositions comprising the hybrid metal oxide particles described herein in the form of an aqueous formulation, an oil-based formulation, an ink, a coating formulation, a food, a plastic, a cosmetic formulation, or a material for a medical application, or a security application.

Other aspects of the present disclosure are directed to bulk compositions exhibiting whiteness, a non-white color, or effect in the ultraviolet spectrum, the bulk composition comprising the hybrid metal oxide particles described herein.

As used herein, the term “bulk sample” refers to a population of particles. For example, a bulk sample of particles is simply a bulk population of particles, for example, ≥0.1 mg, ≥0.2 mg, ≥0.3 mg, 0.4 mg, ≥0.5 mg, ≥0.7 mg, 1.0 mg, 2.5 mg, 5.0 mg, ≥10.0 mg, or ≥25.0 mg. A bulk sample of particles may be substantially free of other components.

Also as used herein, the phrase “exhibits color observable by the human eye” means color will be observed by an average person. This may be for any bulk sample distributed over any surface area, for example, a bulk sample distributed over a surface area of from any of about 1 cm², about 2 cm², about 3 cm², about 4 cm², about 5 cm², or about 6 cm² to any of about 7 cm², about 8 cm², about 9 cm², about 10 cm², about 11 cm², about 12 cm², about 13 cm², about 14 cm 2, or about 15 cm². It may also mean observable by a CIE 1931 2° standard observer and/or by a CIE 1964 10° standard observer. The background for color observation may be any background, for example, a white background, black background, or a dark background anywhere between white and black.

Also as used herein, the term “of” may mean “comprising.” For example, “a liquid dispersion of” may be interpreted as “a liquid dispersion comprising.”

Also as used herein, the terms “particles,” “microspheres,” “microparticles,” “nanospheres,” “nanoparticles,” “droplets,” etc., may refer to, for example, a plurality thereof, a collection thereof, a population thereof, a sample thereof, or a bulk sample thereof.

Also as used herein, the terms “micro” or “micro-scaled,” for example, when referring to particles, mean from 1 micrometer (μm) to less than 1000 μm. The terms “nano” or “nano-scaled,” for example, when referring to particles, mean from 1 nanometer (nm) to less than 1000 nm.

Also as used herein, the term “monodisperse” in reference to a population of particles means particles having generally uniform shapes and generally uniform diameters. A present monodisperse population of particles, for example, may have 90%, 91%, 92%, 93%, 94%, 95%, 96%, 97%, 98%, or 99% of the particles by number having diameters within ±7%, ±6%, ±5%, ±4%, ±3%, ±2%, or ±1% of the average diameter of the population.

Also as used herein, the term “substantially free of other components” means containing, for example, ≤5%, ≤4%, ≤3%, ≤2%, ≤1%, ≤0.5%, K 0.4%, ≤0.3%, ≤0.2%, or ≤0.1% by weight of other components.

The articles “a” and “an” used herein refer to one or to more than one (e.g., at least one) of the grammatical object. Any ranges cited herein are inclusive.

Also as used herein, the term “about” is used to describe and account for small fluctuations. For example, “about” may mean the numeric value may be modified by ±5%, 4%, 3%, 2%, 1%, 0.5%, 0.4%, 0.3%, 0.2%, 0.1%, or 0.05%. All numeric values are modified by the term “about” whether or not explicitly indicated. Numeric values modified by the term “about” include the specific identified value. For example, “about 5.0” includes 5.0.

Unless otherwise indicated, all parts and percentages are by weight. Weight percent (wt %), if not otherwise indicated, is based on an entire composition free of any volatiles, that is, based on dry solids content.

### BRIEF DESCRIPTION OF DRAWINGS

The disclosure described herein is illustrated by way of example and not by way of limitation in the accompanying figures.

FIG. 1 illustrate hybrid metal oxide particles formed from template and matrix metal oxide particles according to certain embodiments of the present disclosure.

FIG. 2 illustrates a comparison of the structure of hybrid metal oxide particles prepared according to certain embodiments of the present disclosure to porous metal oxide particles.

FIG. 3 shows a schematic of an exemplary spray drying system used in accordance with various embodiments of the present disclosure.

FIG. 4 is a scanning electron microscope (SEM) image of silica template, titania matrix hybrid metal oxide particles with ordered structure produced according to embodiments of the present disclosure.

FIG. 5 is an SEM image of disordered silica template, titania matrix hybrid metal oxide particles produced according to embodiments of the present disclosure.

FIG. 6 is a plot of attenuation across the UV-vis spectrum showing increased relative attenuation in the UV range for zinc oxide template, silica matrix hybrid metal oxide particles produced according to embodiments of the present disclosure.

FIG. 7 is an SEM image of further alumina template, silica matrix hybrid metal oxide particles with ordered structure produced according to embodiments of the present disclosure.

### DETAILED DESCRIPTION

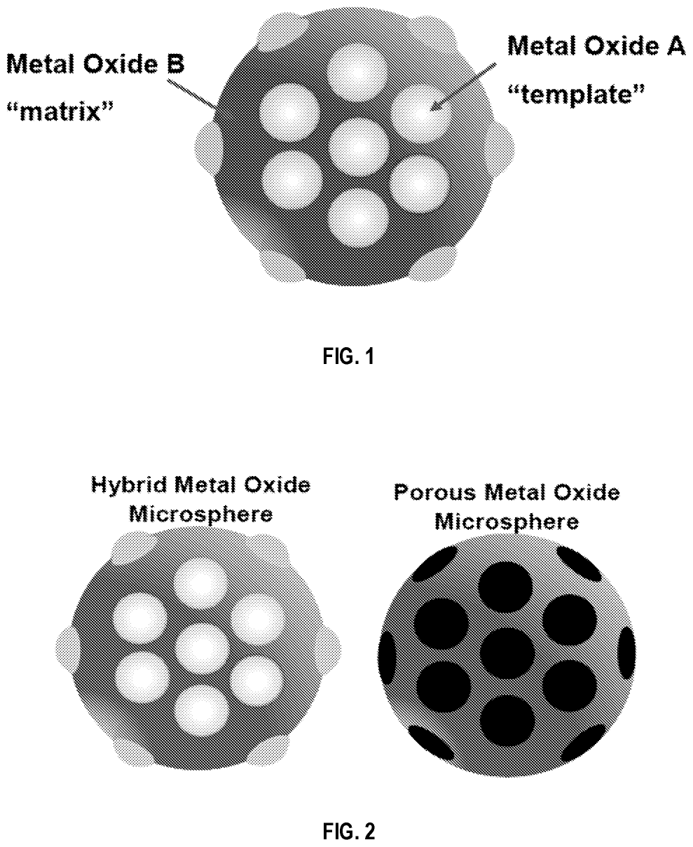

Embodiments of the present disclosure are directed to hybrid metal oxide particles. The hybrid metal oxide particles are in a form of microspheres comprising at least two metal oxides. The microsphere structure comprises a metal oxide matrix in which is embedded a template of spherical nanoparticles comprised of another metal oxide as shown in FIG. 1.

In certain embodiments, the hybrid metal oxide particles are produced by drying droplets of a formulation comprising a matrix of first metal oxide particles (referred to as “matrix” nanoparticles) on the order of 1 to 120 nm in diameter, and second metal oxide nanoparticles (e.g., spherical nanoparticles) on the order of 50 to 999 nm which will form the template (referred to as “template” nanoparticles). In certain embodiments, a spray drying or microfluidics process is used to generate the droplets (e.g., aqueous droplets), and the droplets are dried to remove their solvent. In certain embodiments that utilize a spray drying process, the generation of droplets and drying is performed in rapid succession. During the drying process, the template nanoparticles (metal oxide A of FIG. 1) self-assemble to form a microsphere containing a discrete matrix of metal oxide B particles in which are embedded the template nanoparticles of metal oxide A. The dried particles are then heated under conditions suitable for forming a continuous matrix from the metal oxide B particles in which the metal oxide A particles are embedded. For example, by sintering the matrix nanoparticles (which may contain multiple metal oxides) in a muffle furnace, the matrix nanoparticles densify and form a stable, continuous matrix with the template nanoparticles being retained within the structure. In some embodiments, the droplets further contain a binder (e.g., a material selected from boehmite, alumina sol, silica sol, titania sol, zirconium acetate, ceria sol, or combinations thereof). The dried droplets are then heated under conditions suitable to cause the binder and the metal oxide B particles to form the continuous matrix (e.g., at a temperature of about 300° C. to about 800° C. for a period of about 1 hour to about 8 hours). This final structure is a relatively non-porous solid particle when compared with porous metal oxide microspheres as shown in FIG. 2.

An advantage of this system over a porous metal oxide microsphere is that media infiltration is prevented. The retention of the template in the hybrid metal oxide microsphere ensures that the media cannot infiltrate the structure as it would the voids of the porous metal oxide microsphere. Preventing infiltration maintains a constant net refractive index between the matrix and “void” (nanoparticle template in the case of the hybrid metal oxide microsphere) regardless of the surrounding media in the application.

Hybrid metal oxide particles may be prepared according to various methods, including, but not limited to: (1) methods utilizing colloidal metal oxide matrix particles and colloidal metal oxide template particles; (2) methods utilizing colloidal metal oxide matrix particles, colloidal metal oxide template particles, and binder particles; (3) binder particles alone or binder particles in combination with colloidal metal oxide template particles; and (4) colloidal metal oxide template particles in combination with a sol-gel synthesized metal oxide matrix.

Method (1) utilizes metal oxide template particles embedded in discrete metal oxide matrix particles. The structure can be sintered, fusing the matrix particles into a continuous matrix of metal oxide.

Method (2) utilizes metal oxide template and matrix particles in combination with binder particles. The template particles are embedded in a matrix comprising discrete metal oxide matrix particles and binder particles. The structure is heated resulting in a reaction of the binder particles, which results in the formation of a continuous matrix in which are embedded the metal oxide template particles. In an illustrative example, silica particles are used as the template particles, alumina particles are used as the matrix particles, and boehmite is used as the binder particles. The silica template is embedded in a matrix of alumina and boehmite. The structure is heated to a temperature sufficient to dehydrate the boehmite into alumina, forming a continuous matrix of alumina. If different metal oxide template particles were used, such as titania, the result would be a continuous matrix comprising discrete particles of titania embedded in continuous alumina.

Method (3) utilizes binder particles alone or metal oxide template particles in combination with binder particles. A template of binder particles or colloidal metal oxide particles are embedded in a matrix of binder particles. The structure is heated resulting in a reaction of the binder particles, which results in the formation of a continuous matrix of metal oxide template particles or reacted binder particles.

Method (4) utilizes sol-gel synthesis of a metal oxide matrix. The template particles are dispersed in a solution of a metal oxide precursor, such as a metal alkoxide. Hydrolysis of the metal oxide precursor forms an intermediate that serves as a matrix in which the template particles are embedded. The structure is then heated to undergo hydrolysis and condensation of the matrix, resulting in the formation of a continuous matrix of metal oxide. In an illustrative example, alumina template particles are initially dispersed in a solution of tetraethyl orthosilicate (TEOS). Heating converts the TEOS to silica, resulting in the formation of a continuous matrix of silica in which the alumina template particles are embedded.

The resulting hybrid metal oxide particles may be micron-scaled, for example, having average diameters from about 0.5 μm to about 100 μm. In certain embodiments, the hybrid metal oxide particles have an average diameter from about 0.5 μm, about 0.6 μm, about 0.7 μm, about 0.8 μm, about 0.9 μm, about 1.0 μm, about 5.0 μm, about 10 μm, about 20 μm, about 30 μm, about 40 μm, about 50 μm, about 60 μm, about 70 μm, about 80 μm, about 90 μm, about 100 μm, or within any range defined by any of these average diameters (e.g., about 1.0 μm to about 20 μm, about 5.0 μm to about 50 μm, etc.). The metal oxide employed may also be in particle form, and the particles may be nano-scaled. The metal oxide matrix nanoparticles may have an average diameter, for example, of about 1 nm to about 120 nm. The metal oxide template nanoparticles may have an average diameter, for example, of about 50 nm to about 999 nm. One or more of the template nanoparticles or the matrix nanoparticles may be polydisperse or monodisperse. In certain embodiments, either metal oxide may be provided as metal oxide particles or may be formed from a metal oxide precursor, for example, via a sol-gel technique. An exemplary sol-gel process is described as follows: liquid droplets are generated from a particle dispersion (e.g., an aqueous particle dispersion with a pH of 3-5) comprising metal oxide template nanoparticles and a precursor of a metal oxide. The precursor may be, for example, TEOS or tetramethyl orthosilicate (TMOS) as a silica precursor, titanium propoxide as a titania precursor, or zirconium acetate as a zirconium precursor. The liquid droplets are dried to provide dried particles comprising a hydrolyzed precursor of metal oxide that surrounds and coats the metal oxide template nanoparticles.

Certain embodiments of the hybrid metal oxide particles exhibit color in the visible spectrum at a wavelength range selected from the group consisting of 380 nm to 450 nm, 451 nm to 495 nm, 496 nm to 570 nm, 571 nm to 590 nm, 591 nm to 620 nm, 621 nm to 750 nm, 751 nm to 800 nm, and any range defined therebetween (e.g., 496 nm to 620 nm, 450 nm to 750 nm, etc.). In some embodiments, the particles exhibit a wavelength range in the ultraviolet spectrum selected from the group consisting of 100 nm to 400 nm, 100 nm to 200 nm, 200 nm to 300 nm, and 300 nm to 400 nm.

In certain embodiments, the hybrid metal oxide particles are non-porous or substantially non-porous. In certain embodiments, the hybrid metal oxide particles can have, for example, an average diameter of from about 0.5 μm to about 100 μm. In other embodiments, the particles can have, for example, an average diameter of from about 1 μm to about 75 μm.

In certain embodiments, the hybrid metal oxide particles have an average diameter, for example, of from about 1 μm to about 75 μm, from about 2 μm to about 70 μm, from about 3 μm to about 65 rm, from about 4 μm to about 60 μm, from about 5 μm to about 55 μm, or from about 5 μm to about 50 μm; for example, from any of about 5 μm, about 6 μm, about 7 μm, about 8 μm, about 9 μm, about 10 μm, about 11 μm, about 12 μm, about 13 μm, about 14 μm, or about 15 μm to any of about 16 μm, about 17 μm, about 18 μm, about 19 μm, about 20 μm, about 21 μm, about 22 μm, about 23 μm, about 24 μm, or about 25 μm. Other embodiments can have an average diameter of from any of about 4.5 μm, about 4.8 μm, about 5.1 μm, about 5.4 μm, about 5.7 μm, about 6.0 μm, about 6.3 μm, about 6.6 μm, about 6.9 μm, about 7.2 μm, or about 7.5 μm to any of about 7.8 μm about 8.1 μm, about 8.4 μm, about 8.7 μm, about 9.0 μm, about 9.3 μm, about 9.6 μm, or about 9.9 μm.

In certain embodiments, the hybrid metal oxide particles can have, for example, an average diameter of from any of about 4.5 μm, about 4.8 μm, about 5.1 μm, about 5.4 μm, about 5.7 μm, about 6.0 μm, about 6.3 μm, about 6.6 μm, about 6.9 μm, about 7.2 μm, or about 7.5 μm to any of about 7.8 μm about 8.1 μm, about 8.4 μm, about 8.7 μm, about 9.0 μm, about 9.3 μm, about 9.6 μm, or about 9.9 μm.

In certain embodiments, the template nanoparticles and the matrix nanoparticles independently comprise a metal oxide selected from silica, titania, alumina, zirconia, ceria, iron oxides, zinc oxide, indium oxide, tin oxide, chromium oxide, and combinations thereof. In certain embodiments, the template nanoparticles comprise silica. In certain embodiments, the matrix nanoparticles comprise titania.

In certain embodiments, a weight to weight ratio of the first metal oxide particles to the second metal oxide particles is from about 1/10, about 2/10, about 3/10, about 4/10, about 5/10 about 6/10, about 7/10, about 8/10, about 9/10, to about 10/9, about 10/8, about 10/7, about 10/6, about 10/5, about 10/4, about 10/3, about 10/2, or about 10/1. In certain embodiments, the weight to weight ratio is 2/3 or 3/2.

In certain embodiments, a particle size ratio of the metal oxide matrix particles to the metal oxide template particles is from 1/20 to 1/5 (e.g., 1/10).

In certain embodiments, the matrix nanoparticles have an average diameter of from about 1 nm, about 5 nm, about 10 nm, about 15 nm, about 20 nm, about 25 nm, about 30 nm, about 35 nm, about 40 nm, about 45 nm, about 50 nm, about 55 nm, or about 60 nm to about 65 nm, about 70 nm, about 75 nm, about 80 nm, about 85 nm, about 90 nm, about 95 nm, about 100 nm, about 105 nm, about 110 nm, about 115 nm, or about 120 nm. In other embodiments, the matrix nanoparticles have an average diameter of about 5 nm to about 150 nm, about 50 to about 150 nm, or about 100 to about 150 nm.

In certain embodiments, the template nanoparticles have an average diameter of from about 50 nm, about 100 nm, about 150 nm, about 200 nm, about 250 nm, or about 300 nm to about 350 nm, about 400 nm, about 450 nm, about 500 nm, about 550 nm, or about 600 nm.

In further embodiments, the hybrid metal oxide particles can have, for example, from about 60.0 wt % to about 99.9 wt % metal oxide, based on the total weight of the hybrid metal oxide particles. In other embodiments, the structural colorants comprise from about 0.1 wt % to about 40.0 wt % of one or more light absorbers, based on the total weight of the hybrid metal oxide particles. In other embodiments, the metal oxide is from any of about 60.0 wt %, about 64.0 wt %, about 67.0 wt %, about 70.0 wt %, about 73.0 wt %, about 76.0 wt %, about 79.0 wt %, about 82.0 wt %, or about 85.0 wt % to any of about 88.0 wt %, about 91.0 wt %, about 94.0 wt %, about 97.0 wt %, about 98.0 wt %, about 99.0 wt %, or about 99.9 wt % metal oxide, based on the total weight of the hybrid metal oxide particles.

In certain embodiments, the hybrid metal oxide particles are prepared by a method comprising: generating liquid droplets from a particle dispersion comprising first metal oxide particles (e.g., matrix nanoparticles) and second metal oxide particles (e.g., template nanoparticles); drying the liquid droplets to provide dried particles comprising a matrix of the first metal oxide particles embedded with the second metal oxide particles; and sintering the dried particles to densify the matrix and obtain the hybrid metal oxide particles.

In certain embodiments, a liquid dispersion is first formed, for example, by mixing the first metal oxide particles (e.g., matrix nanoparticles) and the second metal oxide particles (e.g., template nanoparticles) in a liquid medium. In certain embodiments, the liquid dispersion is an aqueous dispersion, an oil dispersion, or a combination thereof.

In certain embodiments, the hybrid metal oxide particles may be recovered, for example, by filtration or centrifugation. The recovered particles may then be placed on a substrate, for example, and dried by evaporating the liquid medium. In certain embodiments, the drying comprises microwave irradiation, oven drying, drying under vacuum, drying in the presence of a desiccant, or a combination thereof to evaporate the liquid medium. In certain embodiments, the evaporation of the liquid medium may be performed in the presence of self-assembly substrates such as conical tubes or silicon wafers.

In certain embodiments, droplet formation and collection occur within a microfluidic device. Microfluidic devices are, for example, narrow channel devices having a micron-scaled droplet junction adapted to produce uniform size droplets, with the channels being connected to a collection reservoir. Microfluidic devices, for example, contain a droplet junction having a channel width of from about 10 μm to about 100 μm. The devices are, for example, made of polydimethylsiloxane (PDMS) and may be fabricated, for example, via soft lithography. An emulsion may be prepared within the device via pumping an aqueous dispersed phase and oil continuous phase at specified rates to the device where mixing occurs to provide emulsion droplets. Alternatively, an oil-in-water emulsion may be utilized. The continuous oil phase comprises, for example, an organic solvent, a silicone oil, or a fluorinated oil. As used herein, “oil” refers to an organic phase (e.g., an organic solvent) immiscible with water. Organic solvents include hydrocarbons, for example, heptane, hexane, toluene, xylene, and the like.

In certain embodiments with liquid droplets, the droplets are formed with a microfluidic device. The microfluidic device can contain a droplet junction having a channel width, for example, of from any of about 10 μm, about 15 μm, about 20 μm, about 25 μm, about 30 μm, about 35 μm, about 40 μm, or about 45 μm to any of about 50 μm, about 55 μm, about 60 μm, about 65 μm, about 70 μm, about 75 μm, about 80 μm, about 85 μm, about 90 μm, about 95 μm, or about 100 μm.

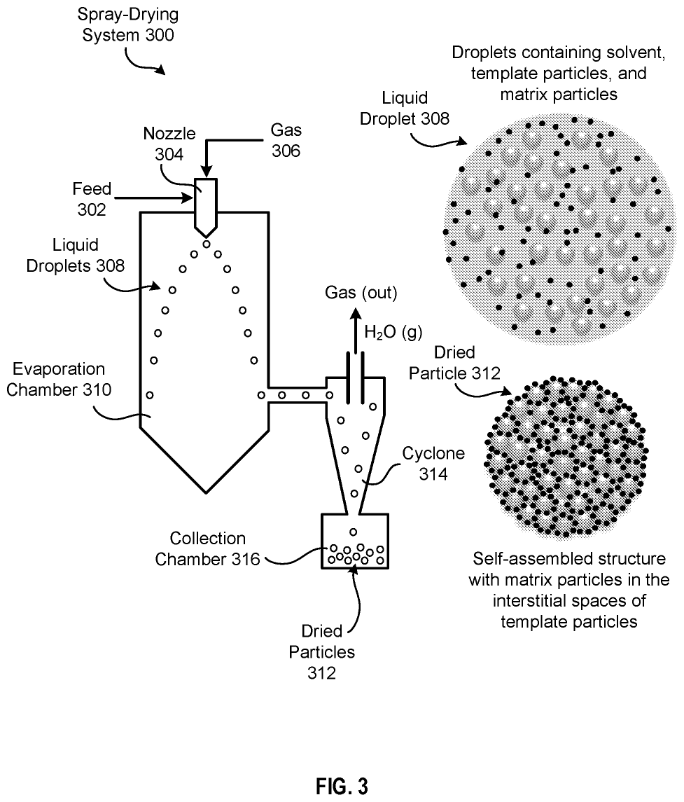

In certain embodiments, generating and drying the liquid droplets is performed using a spray-drying process. FIG. 3 shows a schematic of an exemplary spray drying system 300 used in accordance with various embodiments of the present disclosure. In certain embodiments of spray-drying techniques, a feed 302 of a liquid solution or dispersion is fed (e.g. pumped) to an atomizing nozzle 304 associated with a compressed gas inlet through which a gas 306 is injected. The feed 302 is pumped through the atomizing nozzle 304 to form liquid droplets 308. The liquid droplets 308 are surrounded by a pre-heated gas in an evaporation chamber 310, resulting in evaporation of solvent to produce dried particles 312. The dried particles 312 are carried by the drying gas through a cyclone 314 and deposited in a collection chamber 316. Gases include nitrogen and/or air. In an embodiment of an exemplary spray-drying process, a liquid feed contains a water or oil phase, metal oxide matrix particles, and metal oxide template particles. The dried particles 312 comprise a self-assembled structure of arrayed metal oxide template particles embedded in metal oxide matrix particles.

Air may be considered a continuous phase with a dispersed liquid phase (a liquid-in-gas emulsion). In certain embodiments, spray-drying comprises an inlet temperature of from any of about 100° C., about 105° C., about 110° C., about 115° C., about 120° C., about 130° C., about 140° C., about 150° C., about 160° C., or about 170° C. to any of about 180° C., about 190° C., about 200° C., about 210° C., about 215° C., or about 220° C. In some embodiments a pump rate (feed flow rate) of from any of about 1 mL/min, about 2 mL/min, about 5 mL/min, about 6 mL/min, about 8 mL/min, about 10 mL/min, about 12 mL/min, about 14 mL/min, or about 16 mL/min to any of about 18 mL/min, about 20 mL/min, about 22 mL/min, about 24 mL/min, about 26 mL/min, about 28 mL/min, or about 30 mL/min is utilized.

In some embodiments, vibrating nozzle techniques may be employed. In such techniques, a liquid dispersion is prepared, and then droplets are formed and dropped into a bath of a continuous phase. The droplets are then dried. Vibrating nozzle equipment is available from BÜCHI and comprises, for example, a syringe pump and a pulsation unit. Vibrating nozzle equipment may also comprise a pressure regulation valve.

In certain embodiments, the dried hybrid metal oxide particles are subjected to sintering. The sintering can be performed at temperatures of from about 300° C. to about 800° C. for a period of from about 1 hour to about 8 hours. In some embodiments, if the template nanoparticles are monodisperse and ordered within the dried hybrid metal oxide particles prior to sintering, the ordered arrangement of the template nanoparticles may be substantially preserved in the hybrid metal oxide particles after sintering.

In certain embodiments, the hybrid metal oxide particles comprise mainly metal oxide, that is, they may consist essentially of or consist of metal oxide. Advantageously, depending on the particle compositions, relative sizes, and shapes of the metal oxide particles used, a bulk sample of the hybrid metal oxide particles may exhibit color observable by the human eye, may appear white, or may exhibit properties in the UV spectrum. A light absorber may also be present in the particles, which may provide a more saturated observable color. Absorbers include inorganic and organic materials, for example, a broadband absorber such as carbon black. Absorbers may, for example, be added by physically mixing the particles and the absorbers together or by including the absorbers in the droplets to be dried. In certain embodiments, a hybrid metal oxide particle may exhibit no observable color without added light absorber and exhibit observable color with added light absorber.

The hybrid metal oxide particles described herein may exhibit angle-dependent color or angle-independent color. “Angle-dependent” color means that observed color has dependence on the angle of incident light on a sample or on the angle between the observer and the sample. “Angle-independent” color means that observed color has substantially no dependence on the angle of incident light on a sample or on the angle between the observer and the sample.

Angle-dependent color may be achieved, for example, with the use of monodisperse metal oxide particles (e.g., template particles in the present embodiments). Angle-dependent color may also be achieved when a step of drying the liquid droplets is performed slowly, allowing the particles to become ordered. Angle-independent color may be achieved when a step of drying the liquid droplets is performed quickly, not allowing the particles to become ordered.

The following embodiments may be utilized to achieve angle-dependent color resulting from ordered template particles, with the template and matrix particles comprising different metal oxides (e.g., titania matrix particles and silica template particles). As a first example embodiment of angle-dependent color, monodisperse and spherical template particles are embedded in matrix particles, and the matrix particles are subsequently densified. As a second example embodiment of angle-dependent color, two or more species of template particles that are collectively monodisperse and spherical are embedded in matrix particles, and the matrix particles are subsequently densified. Angle-dependent color is achieved independently of the polydispersity and shapes of the matrix particles.

The following embodiments may be utilized to achieve angle-independent color resulting from disordered template particles, with the template and matrix particles comprising different metal oxides (e.g., titania matrix particles and silica template particles). As a first example embodiment of angle-independent color, polydisperse template particles are embedded in matrix (e.g., metal oxide) particles, and the matrix particles are subsequently densified.

As a second example embodiment of angle-independent color, two different sized spherical template particles (i.e., a bimodal distribution of monodisperse template particles) are embedded in matrix particles, and the matrix particles are subsequently densified. The matrix particles may be spherical or non-spherical.

As a third example embodiment of angle-independent color, two different sized and polydisperse spherical template particles are embedded in matrix particles, and the matrix particles are subsequently densified.

Angle-independent color is achieved independently of the polydispersity and shapes of the matrix particles.

Any of the embodiments exhibiting angle-dependent or angle-independent color may be modified to exhibit whiteness or effects (e.g., reflectance, absorbance) in the ultraviolet spectrum.

In some embodiments, the first metal oxide particles and/or the second metal oxide particles can comprise combinations of different types of particles. For example, the first metal oxide particles may be a mixture of two different metal oxides (i.e., discrete distributions of metal oxide particles), such as a mixture of alumina particles and silica particles with each species being characterized by the same or similar size distributions.

In some embodiments, the first metal oxide particles and/or the second metal oxide particles may comprise more complex compositions and/or morphologies. For example, the first metal oxide particles may comprise particles such that each individual particle comprises two or more metal oxides (e.g., silica-titania particles). Such particles may comprise, for example, an amorphous mixture of two or more metal oxides or may have a core-shell configuration (e.g., titania-coated silica particles, polymer-coated silica, carbon black-coated silica, etc.).

In some embodiments, the first metal oxide particles and/or the second metal oxide particles may comprise surface functionalization. An example of a surface functionalization is a silane coupling agent (e.g., silane-functionalized silica). In some embodiments, the surface functionalization is performed on the first metal oxide particles and/or the second metal oxide particles prior to self-assembly and densification. In some embodiments, the surface functionalization is performed on the hybrid metal oxide particles after densification.

Particle size, as used herein, is synonymous with particle diameter and is determined, for example, by scanning electron microscopy (SEM) or transmission electron microscopy (TEM). Average particle size is synonymous with D50, meaning half of the population resides above this point, and the other half resides below this point. Particle size refers to primary particles. Particle size may be measured by laser light scattering techniques with dispersions or dry powders.

### ILLUSTRATIVE EXAMPLES

The following examples are set forth to assist in understanding the disclosed embodiments and should not be construed as specifically limiting the embodiments described and claimed herein. Such variations of the embodiments, including the substitution of all equivalents now known or later developed, which would be within the purview of those skilled in the art, and changes in formulation or minor changes in experimental design, are to be considered to fall within the scope of the embodiments incorporated herein.

### Example 1: Hybrid Titania Silica Microspheres with Angle-Dependent Ordered Structure

An aqueous suspension of 180 nm spherical silica nanoparticles and 5 nm titania nanoparticles was prepared, which contained 1.8 wt % of the silica nanoparticles and 1.2 wt % of the titania nanoparticles based on a total weight of the aqueous suspension. The aqueous suspension was spray dried under an inert atmosphere (nitrogen) at a 100° C. inlet temperature, a 40 mm spray gas pressure, a 100% aspirator rate, and a 30% flow rate (about 10 mL/min) using a BÜCHI lab-scale spray dryer.

The spray dried powder was removed from the spray dryer's collection chamber and spread onto a silicon wafer for sintering. The spray dried powder was then calcined in a muffle furnace with a batch sintering process to densify and stabilize the microspheres. The heating parameters were as follows: the particles were heated from room temperature to 550° C. over a period of 12 hours, held at 550° C. for 2 hours, and then cooled back to room temperature over a period of 3 hours.

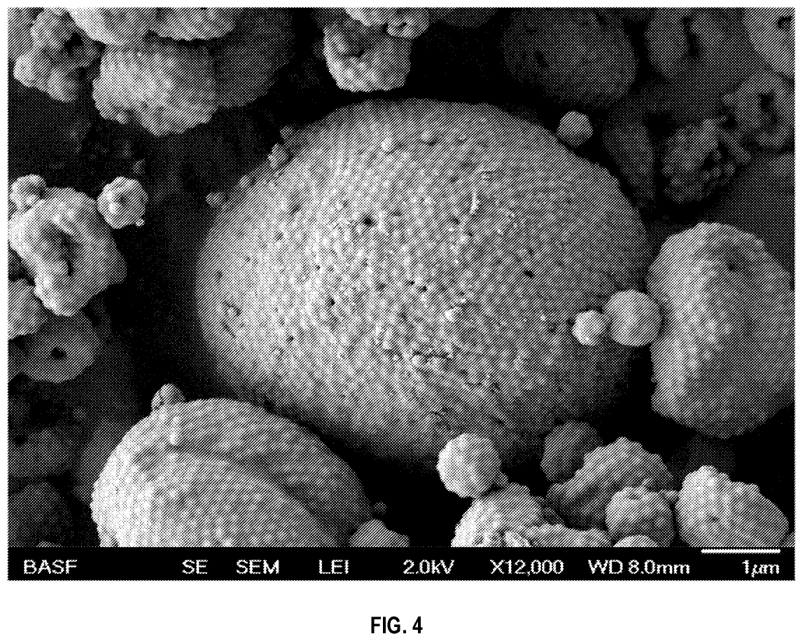

FIG. 4 is an SEM image of hybrid metal oxide particles corresponding to Example 1.

### Example 2: Disordered Hybrid Silica Titania Microspheres

An aqueous suspension of 180 nm spherical silica nanoparticles, 160 nm spherical silica nanoparticles, and 5 nm titania nanoparticles was prepared, which contained 1.2 wt % of the 180 nm silica nanoparticles, 0.6 wt % of the 160 nm silica nanoparticles, and 1.2 wt % of the titania nanoparticles based on a total weight of the aqueous suspension. The aqueous suspension was spray dried under an inert atmosphere (nitrogen) at a 100° C. inlet temperature, a 40 mm spray gas pressure, a 100% aspirator rate, and a 30% flow rate (about 10 mL/min) using a BÜCHI lab-scale spray dryer.

The spray dried powder was removed from the spray dryer's collection chamber and spread onto a silicon wafer for sintering. The spray dried powder was then calcined in a muffle furnace with a batch sintering process to densify and stabilize the microspheres. The heating parameters were as follows: the particles were heated from room temperature to 550° C. over a period of 7 hours, held at 550° C. for 2 hours, and then cooled back to room temperature over a period of 4 hours.

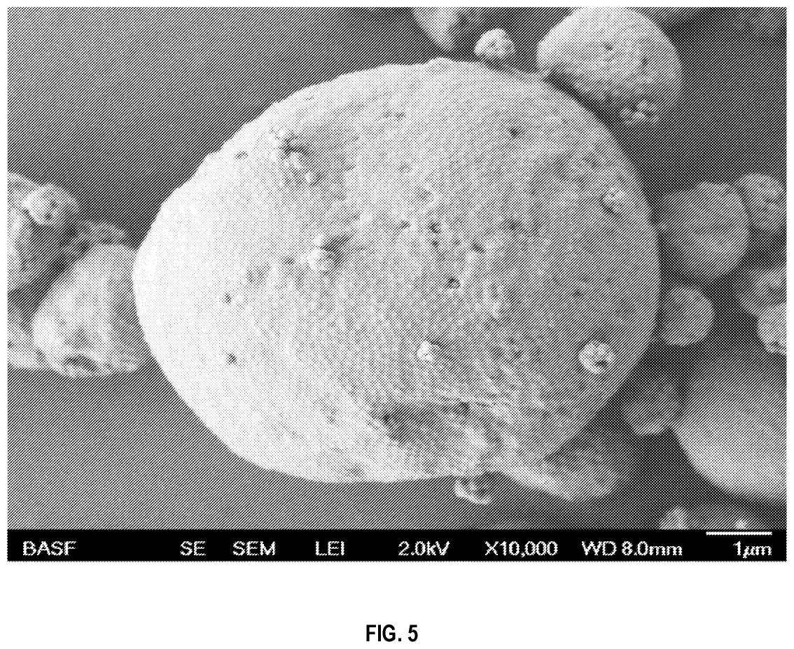

FIG. 5 is an SEM image of hybrid metal oxide particles corresponding to Example 2, demonstrating the presence of disordered template (silica) nanoparticles.

The disordered microspheres display an angle independent blue coloration when dispersed in mineral oil with 1 wt % carbon black per mass of colorant.

### Example 3: Hybrid Zinc Oxide Silica Microspheres Produced Via a Sol-Gel Process

An aqueous suspension of 135 nm zinc oxide nanoparticles was prepared, which contained 1.8 wt % of the 135 nm zinc oxide nanoparticles based on a total weight of the aqueous suspension. TEOS was then dissolved in the suspension at a concentration of 17.4 mg/mL. The aqueous suspension was spray dried under an inert atmosphere (nitrogen) at a 100° C. inlet temperature, a 40 mm spray gas pressure, a 100% aspirator rate, and a 30% flow rate (about 10 mL/min) using a BÜCHI lab-scale spray dryer.

The spray dried powder was removed from the spray dryer's collection chamber and spread onto a silicon wafer for sintering. The spray dried powder was then calcined in a muffle furnace with a batch sintering process to densify and stabilize the microspheres. The heating parameters were as follows: the particles were heated from room temperature to 500° C. over a period of 4 hours, held at 500° C. for 2 hours, and then cooled back to room temperature over a period of 4 hours.

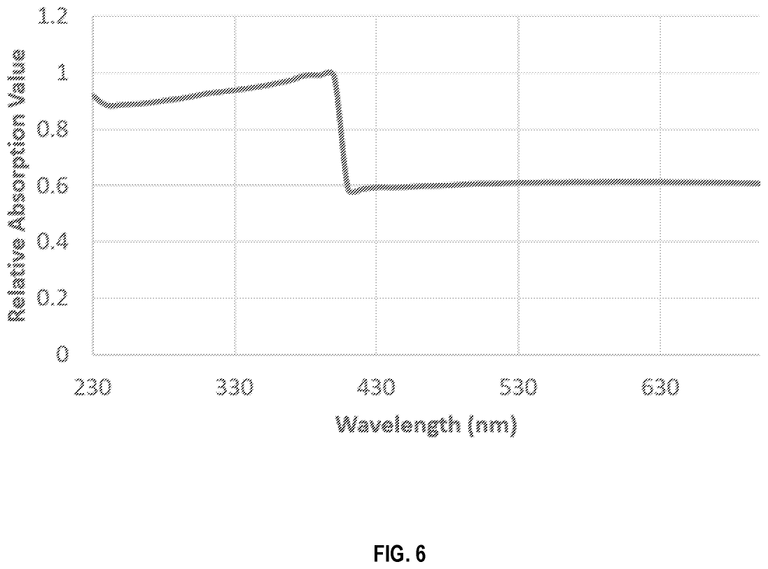

2.5 mg of the microspheres were suspended in 100 mL of acetone and serially diluted in a UV-transparent 96-well plate. The suspensions were dried into powder films and relative attenuation of UV light was measured via a plate reader. The sample exhibited increased attenuation in the UV range as evidenced by a reduction in UV transmission, expressed as a relative absorption value. FIG. 6 is a plot of attenuation across the UV-vis spectrum of a sample of Example 3, showing increased relative attenuation in the UV range.

### Example 4: Hybrid Alumina Silica Microspheres

An aqueous suspension of 300 nm spherical alumina nanoparticles and 5 nm silica nanoparticles was prepared, which contained 1.8 wt % of the 300 nm alumina nanoparticles and 1.2 wt % of the 5 nm silica nanoparticles based on a total weight of the aqueous suspension. The aqueous suspension was spray dried under an inert atmosphere (nitrogen) at a 100° C. inlet temperature, a 40 mm spray gas pressure, a 100% aspirator rate, and a 30% flow rate (about 10 mL/min) using a BÜCHI lab-scale spray dryer.

The spray dried powder was removed from the spray dryer's collection chamber and spread onto a silicon wafer for sintering. The spray dried powder was then calcined in a muffle furnace with a batch sintering process to densify and stabilize the microspheres. The heating parameters were as follows: the particles were heated from room temperature to 500° C. over a period of 4 hours, held at 500° C. for 2 hours, and then cooled back to room temperature over a period of 4 hours.

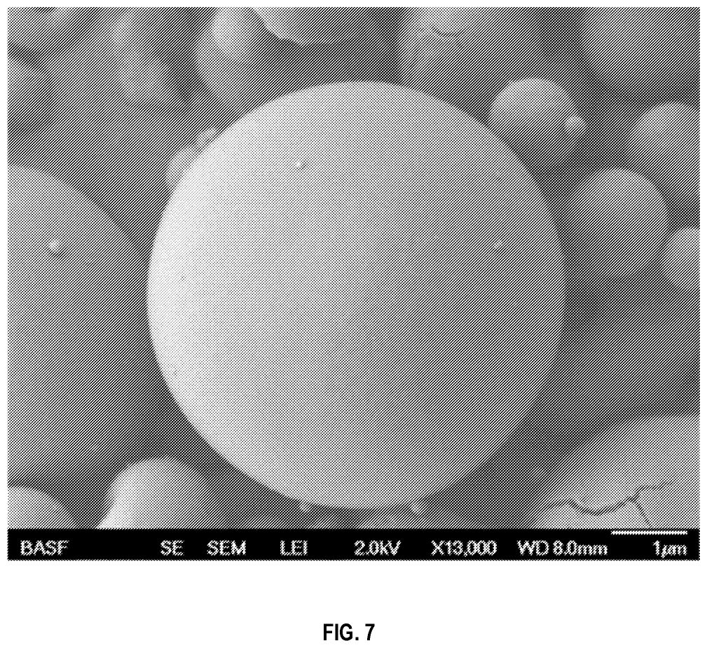

FIG. 7 is an SEM image of hybrid metal oxide particles corresponding to Example 4.

In the foregoing description, numerous specific details are set forth, such as specific materials, dimensions, processes parameters, etc., to provide a thorough understanding of the embodiments of the present disclosure. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this specification to “an embodiment,” “certain embodiments,” or “one embodiment” means that a particular feature, structure, or characteristic described in connection with the embodiment is included in at least one embodiment. Thus, the appearances of the phrase “an embodiment,” “certain embodiments,” or “one embodiment” in various places throughout this specification are not necessarily all referring to the same embodiment, and such references mean “at least one.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A method of preparing hybrid metal oxide particles, the method comprising:
generating liquid droplets from a particle dispersion comprising first metal oxide particles and second metal oxide particles;
drying the liquid droplets to provide dried particles comprising a discrete matrix of the first metal oxide particles embedded with the second metal oxide particles; and
heating the dried particles to obtain the hybrid metal oxide particles comprising a continuous matrix formed from the first metal oxide particles embedded with an array of the second metal oxide particles.

2-31. (canceled)

32. Hybrid metal oxide particles prepared by a method of claim 1.

33. Hybrid metal oxide particles comprising:
a continuous matrix of a first metal oxide having embedded therein an array of metal oxide particles, the metal oxide particles comprising a second metal oxide, wherein the hybrid metal oxide particles are substantially non-porous.

34. The hybrid metal oxide particles of claim 33, wherein the first metal oxide and the second metal oxide independently comprise a metal oxide selected from silica, titania, alumina, zirconia, ceria, iron oxides, zinc oxide, indium oxide, tin oxide, chromium oxide, and combinations thereof.

35. The hybrid metal oxide particles of claim 33, wherein the first metal oxide comprises titania and/or wherein the second metal oxide comprises silica.

36. The hybrid metal oxide particles of claim 33, derived from metal oxide particles comprising the first metal oxide having an average diameter from about 1 nm to about 120 nm.

37. (canceled)

38. The hybrid metal oxide particles of claim 33, wherein the metal oxide particles have an average diameter from about 50 nm to about 999 nm.

39. The hybrid metal oxide particles of claim 33, wherein the metal oxide particles comprise a core-shell structure.

40. The hybrid metal oxide particles of claim 33, wherein the metal oxide particles are spherical metal oxide particles.

41. (canceled)

42. The hybrid metal oxide particles of claim 33, wherein the hybrid metal oxide particles comprise surface functionalization on their outer surfaces.

43. The hybrid metal oxide particles of claim 42, wherein the surface functionalization comprises a silane.

44. The hybrid metal oxide particles of claim 33, wherein the hybrid metal oxide particles have an average diameter from about 0.5 μm to about 100 μm.

45. The hybrid metal oxide particles of claim 33, wherein a weight to weight ratio of the first metal oxide to the second metal oxide is from about 1/50 to about 10/1.

46. The hybrid metal oxide particles of claim 33, wherein a weight to weight ratio of the first metal oxide to the second metal oxide is about 2/3.

47. The hybrid metal oxide particles of claim 33, wherein the array of the metal oxide particles is an ordered array.

48. The hybrid metal oxide particles of claim 33, wherein the array of the metal oxide particles is a disordered array.

49. A composition comprising a substrate and the hybrid metal oxide particles of claim 33, wherein the composition is an aqueous formulation, an oil-based formulation, an ink, a coating formulation, a food, a plastic, a cosmetic formulation or a material for a medical application or a security application.

50. (canceled)

51. A bulk composition exhibiting whiteness, a non-white color, or effect in the ultraviolet spectrum, the bulk composition comprising the hybrid metal oxide particles of claim 33.

52. The hybrid metal oxide particles of claim 33, further comprising a light absorber.

53. The hybrid metal oxide particles of claim 52, wherein the light absorber is present from 0.1 wt % to about 40.0 wt %, and wherein the light absorber comprises carbon black or one or more ionic species.

54-58. (canceled)
